(19) United States
(12) Patent Application Publication
(10) Pub. No.: US 2021/0367854 A1
(43) Pub. Date: Nov. 25, 2021

(54) METHOD FOR DATA COLLECTION USING MULTIPLE NETWORK DATA ANALYTICS FUNCTIONS DEVICE

(71) Applicant: Electronics and Telecommunications Research Institute, Daejeon (KR)

(72) Inventor: Seung-Ik LEE, Daejeon (KR)

(73) Assignee: Electronics and Telecommunications Research Institute, Daejeon (KR)

(21) Appl. No.: 17/167,688

(22) Filed: Feb. 4, 2021

(30) Foreign Application Priority Data
May 22, 2020 (KR) 10-2020-0061331
Aug. 13, 2020 (KR) 10-2020-0101917
Feb. 4, 2021 (KR) 10-2021-0016157

(51) Int. Cl. H04L 12/24; H04L 12/26

(52) U.S. Cl. CPC H04L 41/14; H04L 43/062; H04L 43/04; H04L 41/5058

(57) ABSTRACT

A data collection method using a plurality of network data analytics function devices is disclosed. The data collection method may provide to a consumer NF device by discovering an NWDAF device associated with a target entity and acquiring data collected by the NWDAF device or analytics information that is a result of analyzing the data by the NWDAF device.

### CROSS-REFERENCE TO RELATED APPLICATIONS

This application claims the priority benefit of Korean Patent Application No. 10-2020-0061331 filed on May 22, 2020, Korean Patent Application No. 10-2020-0101917 filed on Aug. 13, 2020 in the Korean Intellectual Property Office and Korean Patent Application No. 10-2021-0016157, filed on Feb. 4, 2021, in the Korean Intellectual Property Office, the disclosures of which are incorporated herein by reference for all purposes.

### BACKGROUND

### 1. Field

One or more example embodiments relate to technology to a data collection method using multiple network data analytics function (NWDAF) devices.

### 2. Description of Related Art

A network data analytics function (NWDAF) device can collect and analyze network data. At this time, in a conventional core network, only single NWDAF device collects and analyzes network data, but the necessity of a plurality of NWDAF devices is required due to the generation of various analytics types and an increase in network data.

### SUMMARY

According to an aspect, there is provided a data collection method performed by a consumer NF (network function) device, comprising: transmitting a discovery request for an NWDAF (network data analytics function) device to an NRF (network repository function) device; receiving a discovery response corresponding to the discovery request from the NRF device; forwarding an analytics request or analytics subscription of data for a target entity to the NWDAF device included in the discovery response; and receiving an analytics response or analytics notification including analytics information of the data from the NWDAF device.

when the discovery response includes a plurality of NWDAF devices, wherein the analytics request or analytics subscription is transmitted to each of the plurality of NWDAF devices, wherein the analytics response or analytics notification is obtained and aggregated from a plurality of NWDAF devices.

wherein the NRF device receives a profile of the NWDAF device including at least one of an analytics ID, a target region of interest, a type of service supported by the NWDAF device, and information about a target entity related to the NWDAF device and registering the NWDAF device in association with the profile.

wherein the type of service includes at least one of collection of data for the target entity, data analytics, data storage, model provisioning or model training for data analytics.

According to an aspect, there is provided a data collection method performed by a NRF (network repository function) device, comprising: receiving a discovery request for an NWDAF (network data analytics function) device from a consumer NF (network function) device; discovering the NWDAF device corresponding to the discovery request; transmitting a discovery response to the discovery request to the consumer NF device; wherein the NRF device registers the NWDAF device with a profile, wherein the discovery response includes information on an NWDAF device corresponding to the discovery request, wherein the NWDAF device provides data analytics information to the consumer NF device.

wherein the NRF device receives a profile of the NWDAF device including at least one of an analytics ID, a target region of interest, a type of service supported by the NWDAF device, and information about a target entity related to the NWDAF device, and registering the NWDAF device in association with the profile.

wherein the type of service includes at least one of collection of data for the target entity, data analytics, data storage, model provisioning or model training for data analytics.

According to an aspect, there is provided a data collection method performed by a consumer NF(network function) device, comprising: transmitting a discovery request for an NWDAF (network data analytics function) device to an NRF (network repository function) device; receiving a discovery response for the NWDAF device corresponding to the discovery request from the NRF device; transmitting a data request or data subscription for data on a target entity to the NWDAF device included in the discovery response; receiving a data response or data notification of data for the target entity from the NWDAF device.

when the discovery response includes a plurality of NWDAF devices, wherein the analytics request or analytics subscription is transmitted to each of the plurality of NWDAF devices, wherein the analytics response or analytics notification is obtained and aggregated from a plurality of NWDAF devices.

wherein the NRF device receives a profile of the NWDAF device including at least one of an analytics ID, a target region of interest, a type of service supported by the NWDAF device, and information about a target entity related to the NWDAF device and registering the NWDAF device in association with the profile.

wherein the type of service includes at least one of collection of data for the target entity, data analytics, data storage, model provisioning or model training for data analytics.

wherein the consumer NF device analyzes the data included in the data response or data notification to generate analytics information of the data and exposes the generated analytics information.

According to an aspect, there is provided a data collection method performed by a NRF (network repository function) device, comprising: receiving a discovery request for an NWDAF device from a consumer NF device; discovering an NWDAF device corresponding to the discovery request; transmitting a discovery response to the discovery request to the consumer NF device; wherein the NRF device registers the NWDAF device with a profile, wherein the discovery response includes information about an NWDAF device corresponding to the discovery request, wherein the NWDAF device provides the data to the consumer NF device.

wherein the NRF device receives a profile of the NWDAF device including at least one of an analytics ID, a target region of interest, a type of service supported by the NWDAF device, and information about a target entity related to the NWDAF device and registering the NWDAF device in association with the profile.

wherein the type of service includes at least one of collection of data for the target entity, data analytics, data storage, model provisioning or model training for data analytics.

According to an aspect, there is provided a data collection method performed by a consumer NF (network function) device, comprising: transmitting an analytics subscription of data for the target entity to the SCP device; and receiving an analytics notification including data analytics information from the SCP device, when there are a plurality of analytics subscriptions of the data, wherein the receiving receives a duplicated analytics notification according to the number of analytics subscriptions.

wherein the analytics information of the data is generated in an NWDAF device that analyzes the data of the target entity, wherein the NWDAF device provides an analytics notification including the analytics information of the data to the SCP device in response to the analytics subscription delivered from the SCP device.

when there are a plurality of the data analytics subscription, wherein the data analytics subscription is recorded in the registry of the SCP (Service Communication Proxy) device.

According to an aspect, there is provided a data collection method performed by a SCP (Service Communication Proxy) device, comprising: receiving an analytics subscription of data for the target entity from the consumer NF (network function) device; recording the analytics subscription in a registry; transmitting the analytics subscription of the data to an NWDAF (network data analytics function) device; receiving an analytics notification corresponding to an analytics subscription of data from the NWDAF device; duplicating the analytics notification according to the number of analytics subscriptions of the data; providing the duplicated analytics notification to the consumer NF device.

wherein the analytics information of the data is generated in the NWDAF device that analyzes the data of the target entity, wherein the NWDAF device provides an analytics notification including analytics information of data to the SCP device in response to the analytics subscription delivered from the SCP device.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram for explaining the operation of a plurality of NWDAF devices according to a one or more embodiment.

FIG. 2 is a diagram illustrating an example of collecting and analyzing data by an NWDAF device according to a one or more embodiment.

FIG. 3 is a flowchart illustrating a process of collecting and analyzing data by an NWDAF device according to a one or more embodiment.

FIG. 4 is a diagram illustrating an example of collecting data by an NWDAF device according to a one or more embodiment.

FIG. 5 is a flowchart illustrating a process of collecting data by an NWDAF device according to a one or more embodiment.

FIG. 6 is a diagram illustrating a process of transmitting a subscription to an SCP device by a plurality of NWDAF devices according to a one or more embodiment.

FIG. 7 is a diagram illustrating a process of receiving an analytics notification through an SCP device by a plurality of NWDAF devices according to a one or more embodiment.

FIG. 8 is a flowchart illustrating a process in which a plurality of NWDAF devices transmit a subscription through an SCP device and receive an analytics notification according to a one or more embodiment.

### DETAILED DESCRIPTION

Hereinafter, reference will now be made in detail to example embodiments with reference to the accompanying drawings, wherein like reference numerals refer to like elements throughout. However, the scope of the disclosure is not limited by those example embodiments.

The terms used herein are mainly selected from general terms currently being used in related art(s). However, other terms may be used depending on development and/or changes in technology, custom, or a preference of an operator. Thus, it should be understood that the terms used herein are terms merely used to describe the example embodiments, rather terms intended to limit the spirit and scope of this disclosure.

In addition, in a specific case, most appropriate terms have been arbitrarily selected by the inventors for ease of description and/or for ease of understanding. In this instance, the meanings of the arbitrarily used terms will be clearly explained in the corresponding description. Hence, the terms should be understood not by the simple names of the terms, but by the meanings of the terms and the following overall description of this specification.

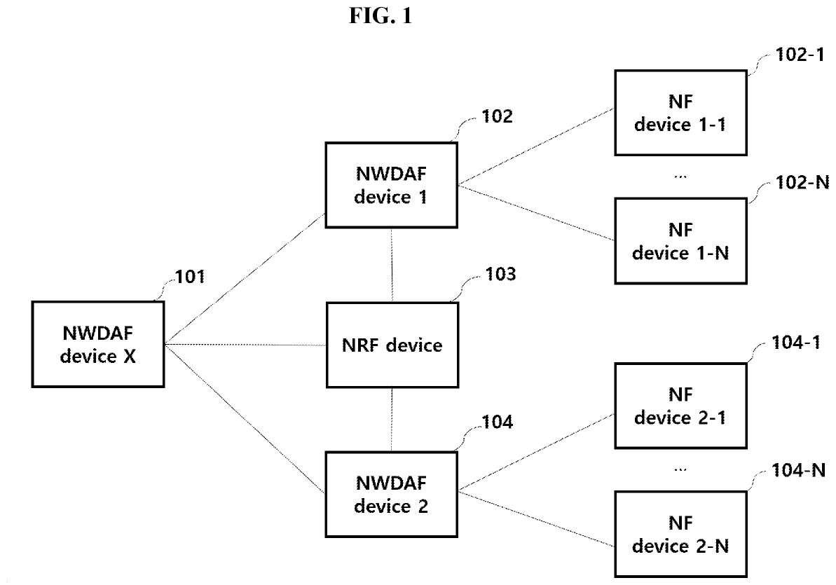

FIG. 1 is a diagram for explaining the operation of a plurality of NWDAF devices according to a one or more embodiment.

In the case of FIG. 1, a Network Data Analytics Function (NWDAF) device-x101 may be one of consumer NF devices. In addition, the NWDAF device-1 102 and the NWDAF device-2 104 may provide services such as data collection, data analytics, data storage, and model provisioning/model training. Further, NWDAF device-1 102 may be associated with NF device-1-1 (102-1) to NF device-1-N (102-N) corresponding to the target entity. And, the NWDAF device-2 104 may be associated with the NF device-1-1 (104-1) to the NF device-1-N (104-N) corresponding to the target entity. The Network Repository Function (NRF) device-103 may store various pieces of information registered by the NWDAF device-1 102 and the NWDAF device-2 104. The NWDAF device-x101 may access the NRF device-103 and identify the NWDAF device-1 102 or the NWDAF device-2 104 corresponding to the requested service. According to the embodiment, number of NWDAF devices registered in the NRF device-103 may be two or more.

According to a one or more embodiment, a plurality of NWDAF devices 102 and 104 may be distributed in a Public Land Mobile Network (PLMN). When a plurality of NWDAF devices 102, 104 are deployed, the architecture of the core network support the NWDAF device as a central NF device, a set of distributed NF devices 102-1 to 102-N, 104-1 to 104-N, or distribution in combination of the two.

As an example, each of the plurality of NWDAF devices 102 and 104 may provide the same type or different types of data analytics. A plurality of NWDAF devices 102 and 104 may interact with each other. According to the embodiment, the NWDAF device-1 102 and the NWDAF device-2 104 may operate independently of each other. A plurality of NWDAF devices 102 and 104 may provide the same type of analytics result to each other, such as a specific analytics for a specific target user equipment or a specific analytics for a specific region of interest.

In addition, although multiple NWDAF devices 102 and 104 provide different types of analytics, they may help each other between multiple NWDAF devices 102 and 104. For example, when the NWDAF device-1 102 provides mobility analytics of the user equipment and the NWDAF device-2 104 provides communication analytics of the user equipment. It may be used to predict the behavioral parameters of the user equipment related to the network data analytics having a tight relationship with the mobility analytics of the user equipment and the communication analytics of the user equipment.

As another example, in order to establish an abnormal behavior related to network data analytics, a plurality of NWDAF devices 102 and 104 may collect a similar type of data required to generate analytics of the mobility pattern of the user equipment and the communication pattern of the user equipment. In order to improve the efficiency of analytics in a network, a plurality of NWDAF devices 102 and 104 need to be able to interact with each other.

The plurality of NWDAF devices 102 and 104 may support a specific type of analytics identified by an analytics ID. In addition, the NRF device-103 may store a profile for each of the plurality of NWDAF devices 102 and 104. The NWDAF device-x101, which is a consumer NF device, may query the NRF device-103 including the analytics ID, and the NRF device may discovery a plurality NWDAF device-102, 104 which supports a specific type of analytics corresponding to the analytics ID.

According to the embodiment, an interaction between a plurality of NWDAF devices 102 and 104 for efficient data collection is supported based on a service-based architecture (SBA) framework.

According to the embodiment, functions of the plurality of NWDAF devices 102 and 104 may be logically decomposed for data collection, data storage, and model provisioning/model learning except for generating analytics data.

Functions logically divided in each of the plurality of NWDAF devices 102 and 104 may be distributed to a separate consumer NF device, the NWDAF device-101.

The plurality of NWDAF devices 102 and 104 may register a service supported by each of the plurality of NWDAF devices 102 and 104 to the NRF device-103 so that other NWDAF devices may discover themselves. Here, the service supported by the plurality of NWDAF devices 102 and 104 may be at least one of data analytics, data collection, data storage, and model provisioning/model training. The plurality of NWDAF devices 102 and 104 may register a service provided by them to the NRF device-103.

According to the embodiment, interaction between a plurality of NWDAF devices 102 and 104 associated with different entities may be supported according to a distributed manner or a hierarchical manner. Here, different entities are a set of NF devices 102-1 to 102-N, 104-1 to 104-N, and NF devices 102-1 to 102-N and 104-1 to 104-N, or a user equipment. (UE) may be included.

According to the embodiment, each of the plurality of NWDAF devices 102, 104 may be pre-configured based on an operator policy to provide a set of entities that wish to collect data or generate analytics data. Here, the entities may include a plurality of user equipment, a plurality of network devices, sets of network devices, or an ROI.

A plurality of NWDAF devices 102, 104 may assist each other to generate an aggregated analytics or collect data from a plurality of sets of target entities. A plurality of NWDAF devices 102 and 104 may be logically associated with a specific set of target entities to serve. The plurality of NWDAF devices 102 and 104 may be co-located with the NF device of the 5G core network according to an operator's deployment choice and may be logically associated with the NF device.

According to the embodiment, a tool is proposed for searching a plurality of NWDAF devices 102, 104 associated with a target entity. For example, the NWDAF device-x101 may register and manage information of a plurality of NWDAF devices 102 and 104 to search for a plurality of NWDAF devices 102 and 104.

Alternatively, a plurality of NWDAF devices 102 and 104 register a profile to the NRF device-103 so that the NWDAF device-x 101, a consumer NF device, may be searched through the NRF device-103.

For example, NWDAF device-1 102 is associated with NF device-1-1 (102-1) and NF device-1-N (102-N), and NWDAF device-2 104 is associated with NF device-2-1 (104-N). 1) and may be registered with the NRF device-103 as being associated with the NF device-2-N 104-N. NWDAF device-X 101) is NF Device-1-1 (102-1), NF device-1-N (102-N), NF Device-2-1 (104-1), NF device-2-N (104-N) The NWDAF device-1 102 and the NWDAF device-2 104 may be discovered through the NRF device-103 in order to obtain the analytics data of. Then, NWDAF device-x101 may provide analytics information on the data of NF device-1-N (102-N), NF device-2-1 (104-1), and NF device-2-N (104-N). Then, NWDAF device-x101 may register itself to NRF device-103 that NWDAF device-x101 is associated with NF device-1-N (102-N), NF device-2-1 (104-1), and NF device-2-N (104-N). At this point, the consumer NF device may obtain analytics information of the data for NF device-1-N (102-N), NF device-2-1 (104-1), NF device-2-N (104-N).

According to the embodiment, a plurality of NWDAF devices 102 and 104 may be deployed in a 5G core network. Multiple NWDAF devices may cooperate with each other. In this case, each of the plurality of NWDAF devices may provide the following.

In order to support the logical decomposition of the functions of the multiple NWDAF devices 102, 104, the multiple NWDAF devices 102, 104 may have different service sets. Here, the service may be at least one of data analytics, data collection, data storage, and model provisioning/model training.

A plurality of NWDAF devices 102, 104 may provide different sets of analytics information related to a specific slice, NF device, set of NF devices, serving area, etc.

A plurality of NWDAF devices (102, 104) may register a profile of a plurality of NWDAF devices (102, 104) including a target entity related to the service to the NRF device (103).

The NWDAF device-x 101 or the NF consumer may use the NRF device-103 to specify the target entity or set of services of the plurality of NWDAF devices 102 and 104 for analytics aggregation or data collection. 104) may be found.

According to a one or more embodiment, a plurality of NWDAF devices 102 and 104 may register services supported by them to the NRF device-103. Here, the service may be at least one of data analytics, data collection, data storage, or model provisioning/training. Here, the model may be used to analyze the data.

According to a one or more embodiment, the NRF device-103 includes (i) services supported by the plurality of NWDAF devices 102 and 104 and (ii) information on the target entity of the plurality of NWDAF devices 102 and 104 or (iii) information on a model trained by a plurality of NWDAF devices 102 and 104 may be registered. The service supported by the plurality of NWDAF devices 102 and 104 may be at least one of data collection, data analytics, data storage, and model provisioning/model training. These services may be registered in association with a plurality of NWDAF devices 102 and 104. In addition, at least one of the target entity may be associated with a plurality of NWDAF devices 102 and 104, and may be at least one of NF devices and sets of NF devices.

Information such as profile registered in the NRF device-103 may be updated. The plurality of NWDAF devices 102 and 104 may update the changed information to the NRF device-103, when (i) services supported by the plurality of NWDAF devices 102 and 104 is changed or (ii) information on the target entity of the plurality of NWDAF devices 102 and 104 is changed. Then, the NRF device-103 registers the latest version of (i) services supported by the plurality of NWDAF devices 102 and 104 and (ii) the information on the target entity of the plurality of NWDAF devices 102 and 104.

In order for the NRF device-103 to support registration and search of a plurality of NWDAF devices 102 and 104, each of the plurality of NWDAF devices 102 and 104 may register parameters of the NF profile by using a message such as Nnrf_NFManagement_NFRegister/NFUpdate. The parameters are as follows.

(i) S-NSSAI (Single Network Slice Selection Assistance Information), analytics ID (analytics ID), NWDAF device service area information (Serving Area information)

(ii) Information on services supported by multiple NWDAF devices 102, 104 (e.g., data analytics, data collection, data storage, model provisioning/model training)

(iii) a set of target NF devices (102-1 to 102-N, 104-1 to 104-N) or a set of target NF devices that are deployed or associated with a plurality of NWDAF devices (102, 104).

### Identification Information

(iv) Trained model information currently available to the NWDAF device (e.g. model type, etc.)

The plurality of NWDAF devices 102 and 104 may update existing registration information in the NRF device-103 by calling Nnrf NFManagement NFUpdate when a supported service is changed or a target entity is changed.

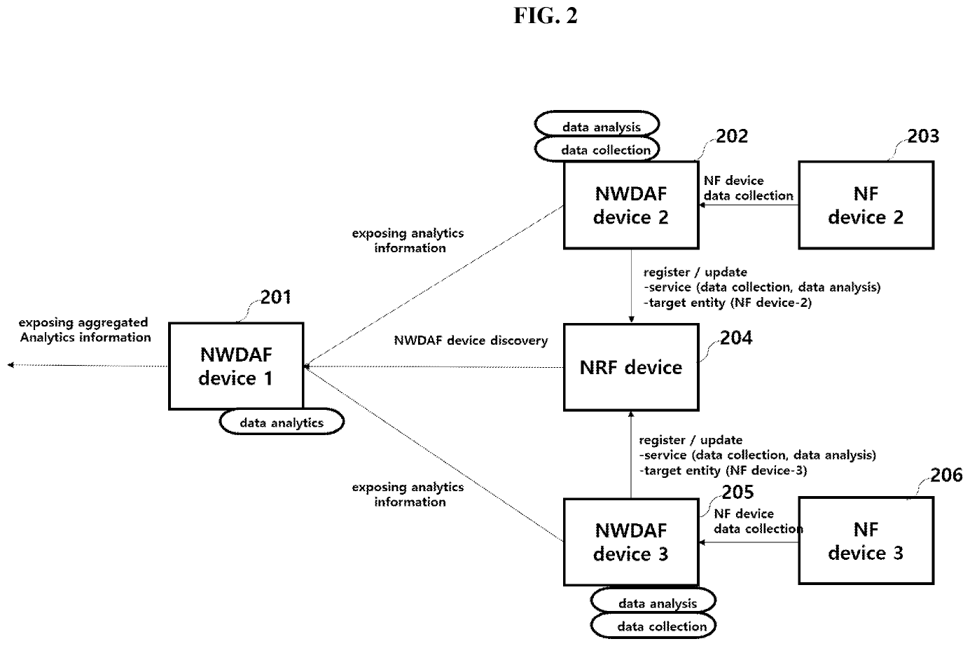

FIG. 2 is a diagram illustrating an example of collecting and analyzing data by an NWDAF device according to a one or more embodiment.

Referring to FIG. 2, NWDAF device-2 202 may collect data of NF device-2 203 by interacting with NF device-2 203 as a target entity. The NWDAF device 3 205 may collect data of the NF device 3 206 by interacting with the NF device 3 206 as a target entity.

In FIG. 2, services supported by the NWDAF device-2 202 and the NWDAF device 3 205 may be data analytics and data collection. The NWDAF device-2 202 and NWDAF device 3 205 may then register the profile with the NRF device-204. At this time, the profile of the NWDAF device-2 202 is the type of service supported by the NWDAF device-2 202 (data analytics and data collection) and the NF device-2 203, which is a target entity associated with the NWDAF device-2 202. May include information about. When the profile is changed, the NWDAF device-2 202 may update the changed profile to the NRF device-204.

Similarly, the profile of NWDAF device 3 205 is to NF device 3 206, which is a target entity associated with NWDAF device 3 205 and the types of services (data analytics and data collection) supported by NWDAF device 3 205 May include information about. When the profile is changed, the NWDAF device 3 205 may update the changed profile to the NRF device-204.

Thereafter, the consumer NF device, NWDAF device-1 201, may need to obtain analytics information of the data of NF device-2 203 and NF device 3 206. Then, the NWDAF device-1 201 may query the NRF device-204 for an NWDAF device associated with each of the target entities NF device-2 203 and NF device 3 206. In response to the query of NWDAF device-1 201, NRF device-204 may discover NWDAF device-2 203 associated with NF device-2 203 and NWDAF device 3 206 associated with NF device 3 205. Then, the NRF device-204 may provide a discovery result of the NWDAF device in response to the query of the NWDAF device-1 201.

Thereafter, the NWDAF device-1 201 may obtain analytics information about the NF device-2 203 from the NWDAF device-2 202. In this case, the NWDAF device-2 202 may collect data from the NF device-2 203 and analyze the collected data to generate analytics information. The NWDAF device-2 202 may provide analytics information by exposing the analytics information on the data of the NF device-2 203 to the NWDAF device-1 201.

In a similar manner, NWDAF device-1 201 may obtain analytics information for NF device 3 206 from NWDAF device 3 205. In this case, the NWDAF device 3 205 may collect data from the NF device 3 206 and analyze the collected data to generate analytics information. The NWDAF device 3 205 may provide analytics information by exposing the analytics information on the data of the NF device 3 206 to the NWDAF device-1 201.

Then, the NWDAF device-1 201 may aggregate the analytics information obtained from the NWDAF device-2 202 and the NWDAF device 3 205. The NWDAF device-1 201 may register the profile with the NRF device-204. In this case, the profile of the NWDAF device-1 201 is service data analytics, and the associated target entity may be set to the NF device-2 203 and the NF device 3 206.

When another NF consumer device requests analytics information on the data of NF device-2 203 and analytics information on the data of NF device 3 206 to NWDAF device-1 201, NWDAF device-1 201 may expose aggregated analytics information.

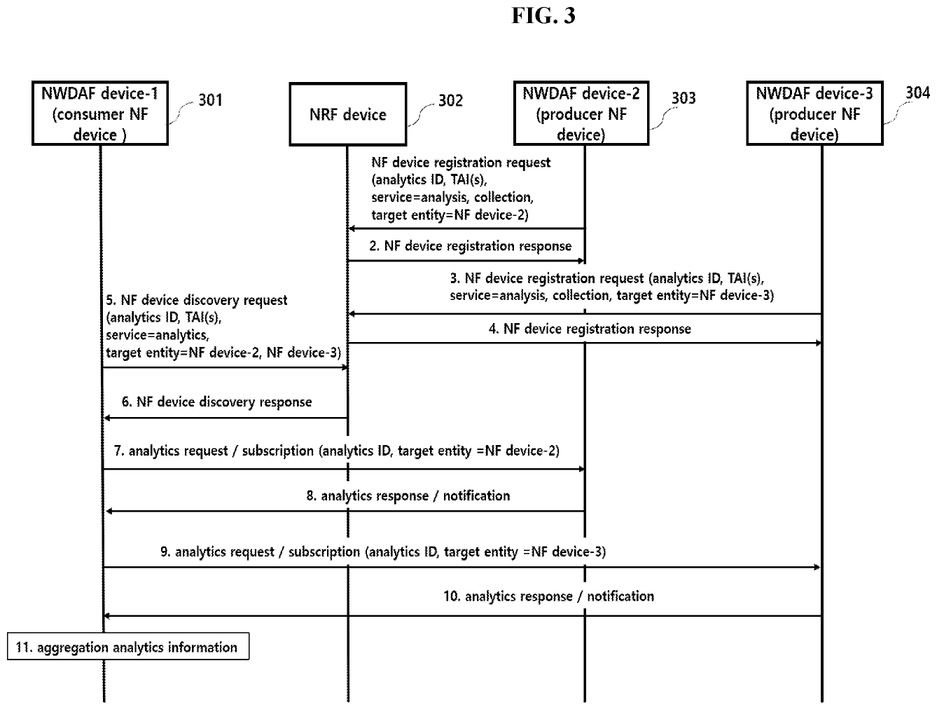

FIG. 3 is a flowchart illustrating a process of collecting and analyzing data by an NWDAF device according to a one or more embodiment.

FIG. 3 is a diagram illustrating the process of FIG. 2.

In step 1, the NWDAF device-2 303 may forward a registration request to the NRF device 302. At this time, the registration request is an analytics ID, a service supported by the NWDAF device-2 303 (data analytics and data collection), a target area of interest (TAI), and a target entity (NF device-2 A profile including) may be included. The target entity may mean an entity currently monitored by the NWDAF device-2 303.

In step 2, the NRF device 302 may register a profile included in the registration request of the NWDAF device-2 303, and then transmit a registration response to the NWDAF device-2 303.

In step 3, the NWDAF device 3 304 may forward a registration request to the NRF device 302. At this time, the registration request is an analytics ID, a service (data analytics and data collection) supported by the NWDAF device 3 304, a target area of interest (TM), and a target entity (NF device 3 A profile including) may be included. The target entity may mean an entity currently monitored by the NWDAF device 3 304.

In step 4, the NRF device 302 may register a profile included in the registration request of the NWDAF device 3 304, and then transmit a registration response to the NWDAF device 3 304.

In step 5, the consumer NF device, NWDAF device-1 301, may forward a discovery request to the NRF device 302. The discovery request may include an analytics ID, a target region of interest, a type of service (analytics), and a target entity (NF device-2 and NF device 3).

In step 6, the NRF device 302 discovers the NWDAF device-2 303 corresponding to the target entity NF device-2 and the NWDAF device 3 304 corresponding to the NF device 3 according to the discovery request, and the NWDAF device-1 (301) may be sent a discovery response.

In step 7, the NWDAF device-1 301 may transmit an analytics request or an analytics subscription to the NWDAF device-2 303 associated with the target entity NF device-2 based on the discovery response received from the NRF device 302. In this case, the analytics request or analytics subscription may include an analytics ID and a target entity (NF device-2).

In step 8, the NWDAF device-2 303 may transmit an analytics response in response to the analytics request transmitted from the NWDAF device-1 301 or transmit an analytics notification in response to an analytics subscription. In this case, the analytics response or analytics notification may include analytics information of the data collected from the NF device-2.

In step 9, the NWDAF device-1 301 may deliver an analytics request or an analytics subscription to the NWDAF device 3 304 associated with the target entity NF device 3, based on the discovery response received from the NRF device 302. In this case, the analytics request or analytics subscription may include an analytics ID and a target entity (NF device 3).

In step 10, the NWDAF device 3 304 may transmit an analytics response in response to the analytics request transmitted from the NWDAF device-1 301 or transmit an analytics notification in response to an analytics subscription. In this case, the analytics response or analytics notification may include analytics information of data collected from the NF device 3.

In step 11, the NWDAF device-1 (301) aggregates the analytics information on the NF device-2 data obtained from the NWDAF device-2 (303) and the analytics information on the NF device 3 data obtained from the NWDAF device 3 (304). can do.

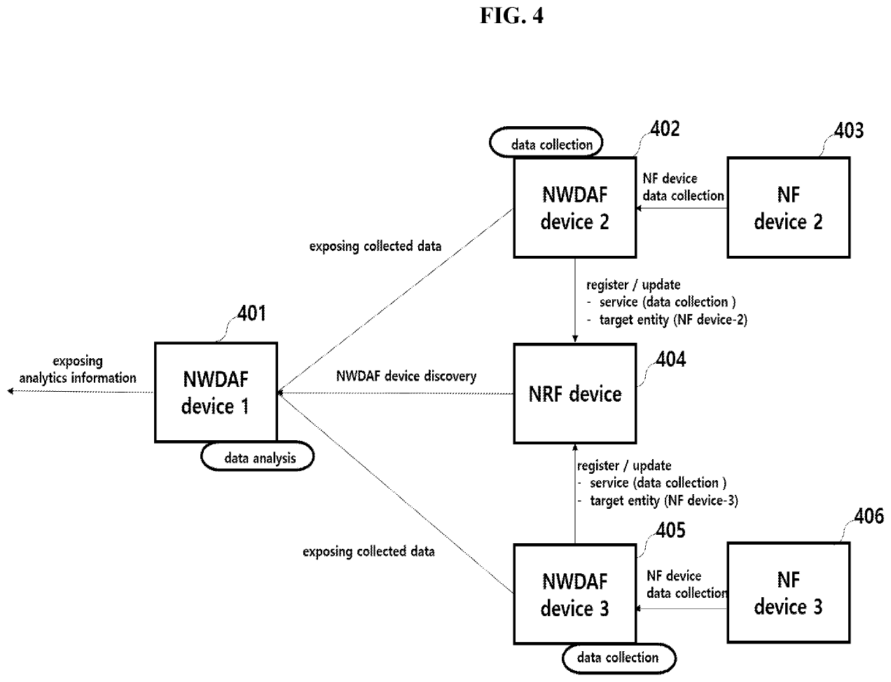

FIG. 4 is a diagram illustrating an example of collecting data by an NWDAF device according to a one or more embodiment.

Referring to FIG. 4, NWDAF device-2 402 may collect data of NF device-2 403 by interacting with NF device-2 403 as a target entity. The NWDAF device 3 405 may collect data of the NF device 3 406 by interacting with the NF device 3 406 as a target entity.

In FIG. 4, a service supported by the NWDAF device-2 402 and the NWDAF device 3 405 may be data collection. 4, unlike FIG. 2, the NWDAF device-2 402 and the NWDAF device 3 405 may not support a service for data analytics.

NWDAF Device-2 402 and NWDAF Device 3 405 may register a profile with the NRF device 404. In this case, the profile of the NWDAF device-2 402 includes information on the type of service (data collection) supported by the NWDAF device-2 402 and information for the NF device-2 403, which is a target entity associated with the NWDAF device-2 402. When the profile is changed, the NWDAF device-2 402 may update the changed profile to the NRF device 404.

Similarly, the profile of NWDAF Device 3 405 contains information on the types of services supported by NWDAF Device 3 405 (data collection) and information for NF Device 3 406, which is a target entity associated with NWDAF Device 3 405. When the profile is changed, the NWDAF device 3 405 may update the changed profile to the NRF device 404.

After that, the consumer NF device, NWDAF device-1 (401), acquires the data of NF device-2 (403) and NF device 3 (406) to analyze the data of NF device-2 (403) and NF device 3 (406). You may want to Then, the NWDAF device-1 401 may query the NRF device 404 for an NWDAF device associated with each of the target entities NF device-2 403 and NF device 3 406. NRF device 404, in response to the query of NWDAF device-1 401, may discover NWDAF device-2 403 associated with NF device-2 403 and NWDAF device 3 406 associated with NF device 3 405. Then, the NRF device 404 may provide a discovery result of the NWDAF device in response to the query of the NWDAF device-1 401.

Thereafter, the NWDAF device-1 401 may obtain the data of the NF device-2 403 from the NWDAF device-2 402. At this time, the NWDAF device-2 402 may collect data from the NF device-2 403. NWDAF device-2 402 may provide data of NF device-2 403 by exposing the data of NF device-2 403 to NWDAF device-1 401.

In a similar manner, NWDAF device-1 401 may obtain data of NF device 3 406 from NWDAF device 3 405. At this time, the NWDAF device 3 405 can read data from the NF device 3 406. NWDAF device 3 405 may provide data of NF device 3 406 by exposing the data of NF device 3 406 to NWDAF device-1 401.

Then, the NWDAF device-1 401 may analyze the data of the NF device-2 403 acquired from the NWDAF device-2 402 and the data of the NF device 3 406 acquired from the NWDAF device 3 405. The NWDAF device-1 401 may register a profile with the NRF device 404. In this case, the profile of the NWDAF device-1 (401) is service is data analytics, and the associated target entity may be set to the NF device-2 (403) and the NF device 3 (406).

When another NF consumer device requests the NWDAF device-1 (401) for analytics information on the data of NF device-2 (403) and the analytics information on the NF device 3 (406), NWDAF device-1 (401) Analytics information may be generated by analyzing data of NF device-2 403 acquired from device-2 402 and data of NF device 3 406 acquired from NWDAF device 3 405. In addition, the NWDAF device-1 401 may expose the generated analytics information.

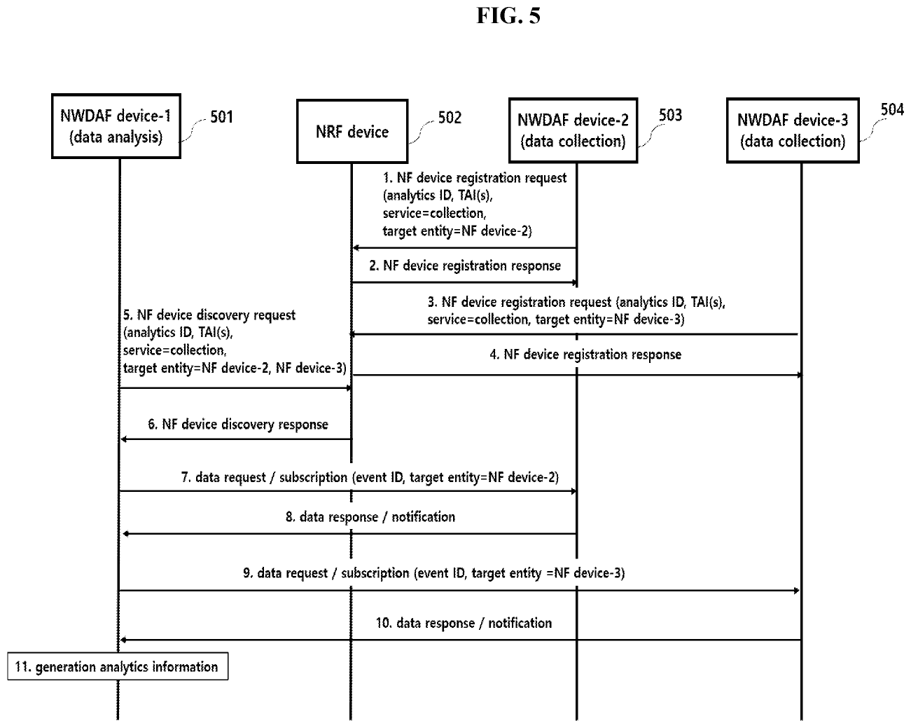

FIG. 5 is a flowchart illustrating a process of collecting data by an NWDAF device according to a one or more embodiment.

FIG. 5 is a flowchart for explaining the process of FIG. 4.

In step 1, the NWDAF device-2 503 may transmit a registration request to the NRF device 502. In this case, the registration request includes a profile for the NWDAF device. The profile includes an analytics ID, a service (data collection) supported by the NWDAF device-2 503, a target area of interest (TAI), and a target entity (NF device-2). The target entity may mean an entity currently monitored by the NWDAF device-2 503.

In step 2, the NRF device 502 may register the profile included in the registration request of the NWDAF device-2 503, and then transmit a registration response to the NWDAF device-2 503.

In step 3, the NWDAF device 3 504 may forward a registration request to the NRF device 502. In this case, the registration request includes a profile for the NWDAF device.

The profile includes an analytics ID, a service (data collection) supported by the NWDAF device 3 504, a target area of interest (TAI), and a target entity (NF device 3). The target entity may mean an entity currently monitored by the NWDAF device 3 504.

In step 4, after registering the profile included in the registration request of the NWDAF device 3 504, the NRF device 502 may transmit a registration response to the NWDAF device 3 504.

In step 5, the consumer NF device, NWDAF device-1 (501), may transmit a discovery request to the NRF device (502). The discovery request may include an analytics ID, a target region of interest, a type of service (analytics), and a target entity (NF device-2 and NF device 3).

In step 6, the NRF device 502 discovers the NWDAF device-2 503 corresponding to the target entity NF device-2 and the NWDAF device 3 504 corresponding to the NF device 3 according to the discovery request, and NWDAF device-1 (501).

In step 7, NWDAF device-1 501 may transmit a data request or data subscription to NWDAF device-2 503 associated with NF device-2, which is a target entity, based on the discovery response received from NRF device 502. In this case, the data request or data subscription may include an event ID and a target entity (NF device-2).

In step 8, the NWDAF device-2 503 may transmit a data response in response to a data request transmitted from the NWDAF device-1 501 or a data notification in response to a data subscription. In this case, the data response or data notification may include information on data collected from the NF device-2.

In step 9, the NWDAF device-1 501 may deliver a data request or a data subscription to the NWDAF device 3 504 associated with the target entity NF device 3, based on the discovery response received from the NRF device 502. In this case, the data request or data subscription may include an analytics ID and a target entity (NF device 3).

In step 10, the NWDAF device 3 504 may transmit a data response in response to a data request transmitted from the NWDAF device-1 501 or an analytics notification in response to a data subscription. In this case, the data response or data notification may include information on data collected from the NF device 3.

In step 11, the NWDAF device-1 (501) analyzes the information on the data of NF device-2 obtained from the NWDAF device-2 (503) and the data of NF device 3 obtained from the NWDAF device 3 (504) and generates the analytics information for the above data.

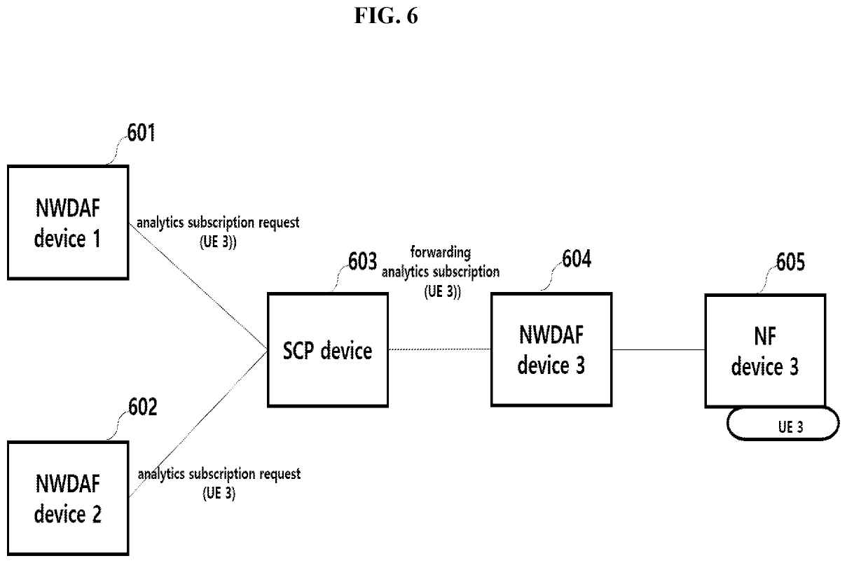

FIG. 6 is a diagram illustrating a process of transmitting a subscription to an SCP device by a plurality of NWDAF devices according to a one or more embodiment.

The SCP (Service Communication Proxy) device shown in FIG. 6 may perform coordination of a duplicated subscription message or notification message for analytics information collection.

The NWDAF device 3 604 may register information on the target entity (eg, NF device 3 or user equipment) to the NRF device. In the case of FIG. 6, only one NWDAF device 604 associated with the NF device 3 605 is shown, but the case where a plurality of NWDAF devices exist is not limited. The SCP device maintains a publication/subscription registry to coordinate and consolidate subscription and notification messages for analytics information.

NWDAF device 3 604 needs to update the data to the NRF device.

The NWDAF device 3 604 may register with the NRF device using the following parameters in Nnrf NFManagement NFRegister.

(i) S-NSSAI, analytics ID, service area information of NWDAF device 3 (604)

(ii) Identification information for NF Device 3 605, which is a target entity co-located or associated with NWDAF Device 3 604

(iii) SUPI (Subscription Permanent Identifier) list for a user equipment that is a target entity monitored or associated by the NWDAF device 3 604

When the target entity is changed for data analytics currently being performed, the NWDAF device 3 604 may call an Nnrf_NFManagement_NFUpdate message to update a profile, which is information registered in the NRF device.

Referring to FIG. 6, the NWDAF device-1 601 and the NWDAF device-2 602 may transmit an analytics subscription to the data of the NF device 3 605, which has the data of the user equipment 3, to the SCP device 603.

Then, the SCP device 603 may transmit the subscription information obtained from the NWDAF device-1 601 and the NWDAF device-2 602 to the NWDAF device 3 604. The SCP device 603 may perform issuance of an analytics subscription or maintain a subscription registry to record a request for an analytics subscription in the registry and stop transmitting the same analytics information for duplicate subscription requests.

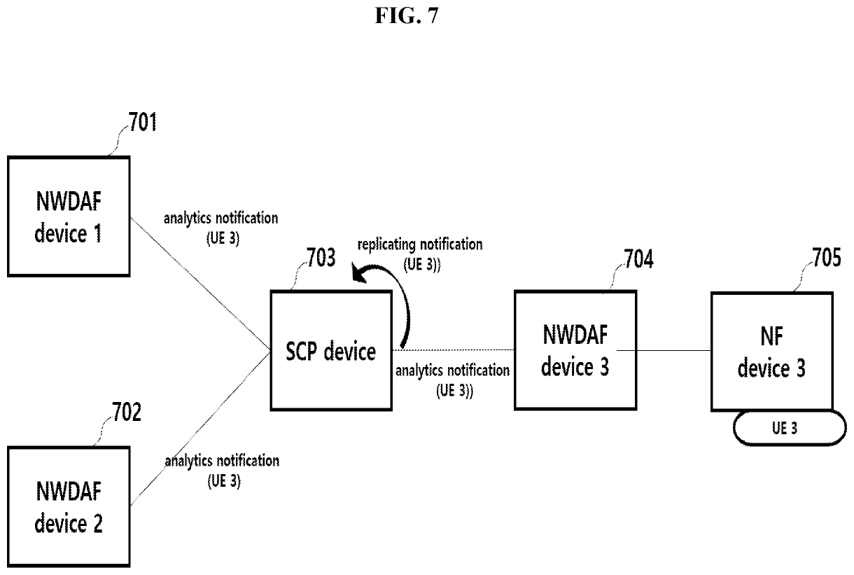

FIG. 7 is a diagram illustrating a process of receiving an analytics notification through an SCP device by a plurality of NWDAF devices according to a one or more embodiment.

The SCP device 703 may receive a notification message from the NWDAF device 3 704. In this case, the notification message includes analytics information of the data on the user equipment 3. Analytics information is generated by the NWDAF device 3 704, which has obtained data from the NF device 3 705, analyzes the data.

When the NWDAF device 3 704 transmits an analytics notification including the analytics information to the SCP device 703, the SCP device 703 may duplicate the notification. The number of copies may vary depending on the number of entities (eg, NWDAF device-1 701 and NWDAF device-2 702) requesting an analytics subscription.

The SCP device 703 may duplicate the notification message including the analytics information and deliver it to the NWDAF device-1 701 and NWDAF device-2 702, each of the subscribers recorded in the subscription registry. Then, the NWDAF device-1 701 and the NWDAF device-2 702 that have subscribed to the analytics in FIG. 6 may acquire analytics information included in the notification message copied by the SCP device 703. In this case, the analytics information may mean a result of analyzing data on the user equipment 3 by the NWDAF device 3.

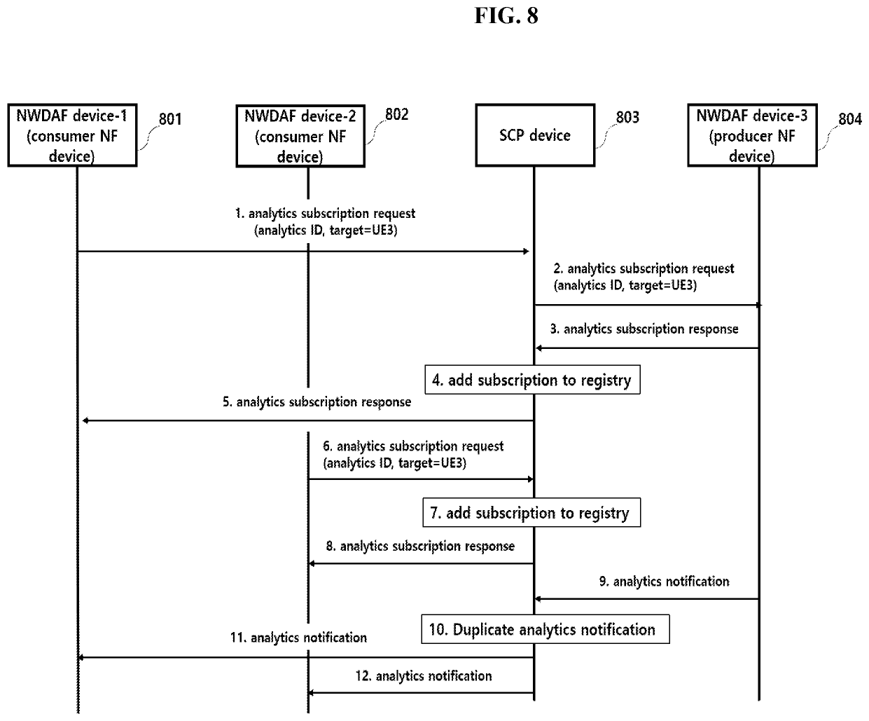

FIG. 8 is a flowchart illustrating a process in which a plurality of NWDAF devices transmit a subscription through an SCP device and receive an analytics notification according to a one or more embodiment.

In step 1, the consumer NF device, the NWDAF device-1 (801), may request the SCP device (803) for an analytics subscription. The analytics subscription may include an analytics ID and a target entity, user equipment 3. The target entity may refer to a device that generates or holds data to be analyzed.

In step 2, the SCP device 803 may transmit a request for an analytics subscription obtained from the NWDAF device-1 801 to the NWDAF device 3 804.

In step 3, the SCP device 804 may receive a response of the analytics subscription from the NWDAF device-1 (801).

In step 4, the SCP device 804 may add a subscription to the NWDAF device-1 801 to the registry.

In step 5, the SCP device 804 may deliver a response of the analytics subscription to the request for the analytics subscription of the NWDAF device-1 (801).

In step 6, the consumer NF device NWDAF device-2 802 may request an analytics subscription from the SCP device 803. The analytics subscription may include an analytics ID and a target entity, user equipment 3. The target entity may refer to a device that generates or holds data to be analyzed.

In step 7, the SCP device 804 may add a subscription to the NWDAF device-2 802 to the registry. At this time, when the analytics subscription for the NWDAF device-2 802 and the analytics subscription for the NWDAF device-1 801 are the same, the SCP device 804 requests the analytics subscription of the NWDAF device 3 803 delivered later May not be delivered to NWDAF device 3 (804).

In step 8, the SCP device 804 may deliver a response of the analytics subscription to the request for the analytics subscription of the NWDAF device-2 802.

In step 9, the NWDAF device 3 804 may transmit an analytics notification including the analytics information of the data on the user equipment 3 to the SCP device 803.

In step 10, the SCP device 803 may duplicate the analytics notification delivered by the NWDAF device 3 804 based on the number of subscriptions added to the registry. In the case of FIG. 8, the SCP device 803 may duplicate two analytics notifications based on the analytics subscription to the NWDAF device-1 (801) and the analytics subscription to the NWDAF device-2 (802).

In step 11, the SCP device 803 may transmit a duplicated analytics notification to the NWDAF device-1 801. The duplicated analytics notification may include analytics information of data on the user equipment 3.

In step 12, the SCP device 803 may transmit a duplicated analytics notification to the NWDAF device-2 802. The duplicated analytics notification may include analytics information of data on the user equipment 3.

The units and/or modules described herein may be implemented using hardware components and software components. For example, the hardware components may include microphones, amplifiers, band pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable gate array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claim.

1. A data collection method performed by a consumer NF (network function) device, comprising:
transmitting a discovery request for an NWDAF (network data analytics function) device to an NRF (network repository function) device;
receiving a discovery response corresponding to the discovery request from the NRF device;
transmitting analytics request or analytics subscription to the NWDAF device; and
receiving an analytics response or analytics notification from the NWDAF device,
wherein the NWDAF device sends analytics response or analytics notification including analytics information for analytics ID aggregated from a plurality of other NWDAF devices.

2. The data collection method of claim 1, when the discovery response includes a plurality of NWDAF devices, wherein the analytics request or analytics subscription is transmitted to each of the plurality of NWDAF devices,
wherein the analytics response or analytics notification is obtained and aggregated from a plurality of NWDAF devices.

3. The data collection method of claim 1, wherein the NRF device receives a profile of the NWDAF device including at least one of an analytics ID, a target region of interest, a type of service supported by the NWDAF device, and information about a target entity related to the NWDAF device and registers the NWDAF device in association with the profile.

4. The data collection method of claim 3, wherein the type of service includes at least one of collection of data for the target entity, data analytics, data storage, model provisioning or model training for data analytics.

5. A data collection method performed by a NRF (network repository function) device, comprising:
receiving a discovery request for an NWDAF (network data analytics function) device from a consumer NF (network function) device;
discovering the NWDAF device corresponding to the discovery request; and
transmitting a discovery response to the discovery request to the consumer NF device,
wherein the NRF device registers the NWDAF device with a profile,
wherein the NWDAF device sends analytics response or analytics notification including analytics information for analytics ID aggregated from a plurality of other NWDAF devices, to the consumer NF device.

6. The data collection method of claim 5, wherein the NRF device receives a profile of the NWDAF device including at least one of an analytics ID, a target region of interest, a type of service supported by the NWDAF device, and information about a target entity related to the NWDAF device and registers the NWDAF device in association with the profile.

7. The data collection method of claim 6, wherein the type of service includes at least one of collection of data for the target entity, data analytics, data storage, model provisioning or model training for data analytics.

8. A data collection method performed by a consumer NF (network function) device, comprising: transmitting a discovery request for an NWDAF (network data analytics function) device to an NRF (network repository function) device;
receiving a discovery response for the NWDAF device corresponding to the discovery request from the NRF device;
transmitting an analytics request or analytics subscription to the NWDAF device; and
receiving an analytics response for the analytics request or an analytics notification for the analytics subscription from the NWDAF device,
wherein the NWDAF sends analytics response or analytics notification including analytics information for analytics ID aggregated from a plurality of other NWDAF devices, to the consumer NF device.

9. The data collection method of claim 8, when the discovery response includes a plurality of NWDAF devices, wherein the analytics request or analytics subscription is transmitted to each of the plurality of NWDAF devices,
wherein the analytics response or analytics notification is obtained and aggregated from a plurality of NWDAF devices.

10. The data collection method of claim 8, wherein the NRF device receives a profile of the NWDAF device including at least one of an analytics ID, a target region of interest, a type of service supported by the NWDAF device, and information about a target entity related to the NWDAF device and registers the NWDAF device in association with the profile.

11. The data collection method of claim 10, wherein the type of service includes at least one of collection of data for the target entity, data analytics, data storage, model provisioning or model training for data analytics.

12. The data collection method of claim 8, wherein the consumer NF device analyzes the data included in the data response or data notification to generate analytics information of the data and exposes the generated analytics information.
